(19) United States
(12) Patent Application Publication
(10) Pub. No.: US 2024/0123268 A1
(43) Pub. Date: Apr. 18, 2024

(54) Fire Protection System

(71) Applicant: Tony Evans, Riverside, CA (US)

(72) Inventor: Tony Evans, Riverside, CA (US)

(21) Appl. No.: 17/966,153

(22) Filed: Oct. 14, 2022

(51) Int. Cl. A62C 3/02

(52) U.S. Cl. CPC A62C 3/0292; A62C 3/0214; A62C 3/0271

(57) ABSTRACT

A fire protection system for retarding the spread of wildfire toward a structure includes a structure positioned on a ground surface. A tank contains a fire retardant fluid. Each of a plurality of sprinklers has a base coupled to the ground surface with a line extending outwardly away from ground surface. Each sprinkler has a nozzle coupled to a distal end of the line relative to the ground surface. The line of each sprinkler is fluidically coupled to the nozzle and the base. Each of a plurality of heat sensors is positioned proximate a respective sprinkler of the plurality of sprinklers. When one of the plurality of heat sensors detects a predetermined rate of heat, a CPU activates a pump to pump the fire retardant fluid from the tank to the base of each sprinkler.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire protection systems and more particularly pertains to a new fire protection system for retarding the spread of wildfire toward a structure.

### (2) Description of Related Art Including Information Disclosed Under 37 CFR 1.97 and 1.98

The prior art relates to fire protection systems, some of which utilize fire sensors placed at or away from a structure to automatically pump water or another fire retardant fluid through a plurality of sprinklers to slow the spread of a wildfire toward and across the structure. However, none of the prior art positions each of a plurality of heat sensors proximate each of a plurality of sprinklers which triggers the pumping of a fire retardant fluid through all of the sprinklers such that the sprinklers dispense the fire retardant fluid onto one of a portion of ground surrounding the structure and a top side of the structure.

### BRIEF SUMMARY OF THE INVENTION

An embodiment of the disclosure meets the needs presented above by generally comprising a structure positioned on a ground surface. A tank contains a fire retardant fluid. Each of a plurality of sprinklers has a base coupled to the ground surface with a line extending outwardly away from ground surface. Each sprinkler has a nozzle coupled to a distal end of the line relative to the ground surface. The line of each sprinkler is fluidically coupled to the nozzle and the base. Each of a plurality of heat sensors is positioned proximate a respective sprinkler of the plurality of sprinklers. When one of the plurality of heat sensors detects a predetermined rate of heat, a CPU activates a pump to pump the fire retardant fluid from the tank to the base of each sprinkler. The fire retardant fluid is dispensed onto one of the structure and a portion of the ground surface surrounding the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a fire protection system according to an embodiment of the disclosure.

FIG. 2 is a detail view of an embodiment of the disclosure as seen in circle 2 in FIG. 1.

FIG. 3 is a block diagram view of an embodiment of the disclosure.

### DETAILED DESCRIPTION OF THE INVENTION

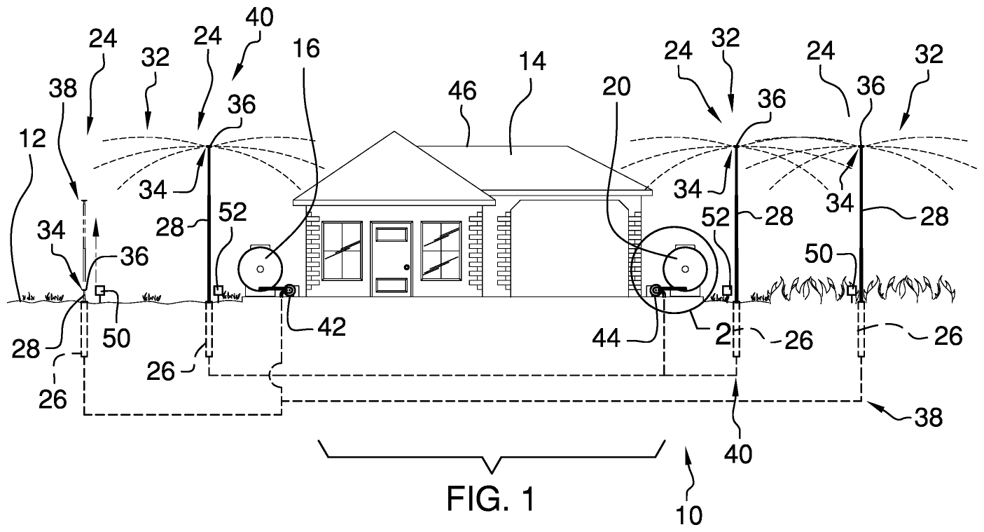

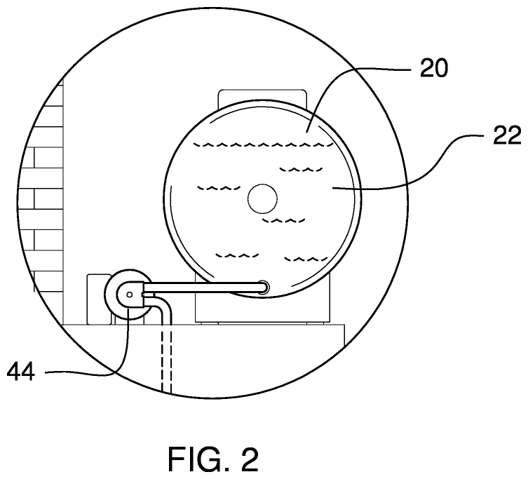

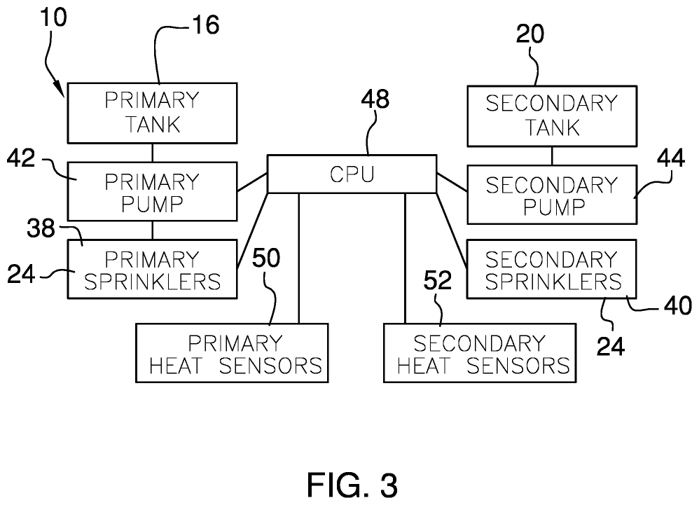

With reference now to the drawings, and in particular to FIGS. 1 through 6 thereof, a new fire protection system embodying the principles and concepts of an embodiment of the disclosure and generally designated by the reference numeral 10 will be described.

As best illustrated in FIGS. 1 through 6, the fire protection system 10 generally comprises a ground surface 12 and a structure 14 positioned on the ground surface 12. A primary tank 16 contains a first fire retardant fluid, and a secondary tank 20 contains a second fire retardant fluid 22. Each of a plurality of sprinklers 24 has a base 26 that is embedded below the ground surface 12 and a line 28 telescopically coupled to the base 26 which extends outwardly away from the ground surface 12. The line 28 is movable between a retracted position and an extended position 32, wherein the line 28 is positioned entirely under the ground surface 12 in the retracted position and is positioned entirely above the ground surface 12 in the extended position 32. Each sprinkler 24 has a plurality of nozzles 34 at a distal end 36 of the line 28 relative to the ground surface 12. The line 28 is fluidically coupled to each nozzle 34 of the plurality of nozzles 34 and the base 26. The line 28 is also elongated between the base 26 and the distal end 36, and each nozzle 34 faces away from a central longitudinal axis of the line 28. The plurality of sprinklers 24 comprises a plurality of primary sprinklers 38 and a plurality of secondary sprinklers 40. The plurality of the secondary sprinklers 40 is positioned along a secondary boundary surrounding the structure 14, and the plurality of the primary sprinklers 38 is positioned along a primary boundary surrounding the structure 14 and the secondary boundary.

A primary pump 42 is fluidically coupled to the primary tank 16 and the plurality of primary sprinklers 38. The primary pump 42 selectively pumps the first fire retardant fluid to the base 26 of each primary sprinkler 38 and through each primary sprinkler 38 such that the first fire retardant fluid is dispensed onto an outer portion of the ground surface surrounding the structure 14. A secondary pump 44 is fluidically coupled to the secondary tank 20 and the plurality of secondary sprinklers 40. The secondary pump 44 selectively pumps the second fire retardant fluid 22 to the base 26 of each secondary sprinkler 40 and through each secondary sprinkler 40 such that the second fire retardant fluid 22 is dispensed onto an inner portion of the ground surface surrounding the structure 14 and onto a top side 46 of the structure 14.

A central processing unit (CPU) 48 is operationally coupled to the primary pump 42 and the secondary pump 44, wherein the CPU 48 is operationally coupled to the plurality of sprinklers 24 and selectively moves the line 28 of each sprinkler 24 between the retracted position and the extended position 32. Each of a plurality of primary heat sensors 50 is positioned proximate a respective primary sprinkler 38 of the plurality of primary sprinklers 38. Each primary heat sensor 50 is operationally and signally coupled to the CPU 48 and is configured for generating a primary actuation signal if detecting a first predetermined rate of heat. When one of the primary heat sensors 50 generates the primary actuation signal, the CPU 48 is operable to move the line 28 of each primary sprinkler 38 to the extended position 32 and actuate the primary pump 42. Each of a plurality of secondary heat sensors 52 is positioned proximate a respective secondary sprinkler 40 of the plurality of secondary sprinklers 40. Each secondary heat sensor 52 is operationally and signally coupled to the CPU 48 and is configured for generating a secondary actuation signal if detecting a second predetermined rate of heat. When one of the secondary heat sensors 52 generates the secondary actuation signal, the CPU 48 is operable to move the line 28 of each secondary sprinkler 40 to the extended position 32 and actuate the secondary pump 44.

In use, a wildfire that reaches the primary boundary will cause at least one primary heat sensor 50 to detect the first predetermined rate of heat. In response, the CPU 48 will move the line 28 of each primary sprinkler 38 into the extended position 32 and activate the primary pump 42 to pump the first fire retardant fluid through the plurality of primary sprinklers 38. If the wildfire reaches beyond the primary boundary to the secondary boundary, it will cause at least one secondary heat sensor 52 to detect the second predetermined rate of heat. Consequently, the CPU 48 will move the line 28 of each secondary sprinkler 40 into the extended position 32 and activate the secondary pump 44 to pump the second fire retardant fluid 22 through the plurality of secondary sprinklers 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire protection system comprising:
a ground surface;
a structure positioned on said ground surface;
a fire retardant fluid;
a tank containing said fire retardant fluid;
a plurality of sprinklers, each said sprinkler having a base being coupled to said ground surface, each said sprinkler having a line coupled to said base and extending outwardly away from said ground surface, each said sprinkler having a nozzle at a distal end of said line relative to said ground surface, said line being fluidically coupled to said nozzle and said base;
a pump being fluidically coupled to said tank and said sprinkler, said pump selectively pumping said fire retardant fluid to said base of each said sprinkler and through each said sprinkler such that said fire retardant fluid is dispensed onto one of said structure and a portion of said ground surface surrounding said structure;
a central processing unit (CPU) being operationally coupled to said pump; and
a plurality of heat sensors, each said heat sensor being positioned proximate a respective sprinkler of said plurality of sprinklers, each said heat sensor being operationally and signally coupled to said CPU, each said heat sensor being configured for generating an actuation signal if detecting a predetermined rate of heat, said CPU being operable to actuate said pump when one of said heat sensors generates said actuation signal.

2. The system of claim 1, further comprising said base of each said sprinkler being embedded below said ground surface.

3. The system of claim 1, further comprising said line of each said sprinkler being movable between a retracted position and an extended position.

4. The system of claim 3, further comprising said line of each said sprinkler being positioned entirely under said ground surface in said retracted position, said line being positioned entirely above said ground surface in said extended position.

5. The system of claim 3, further comprising said CPU selectively moving said line each said sprinkler between said retracted position and said extended position.

6. The system of claim 5, further comprising said CPU being operable to move said line of each said sprinkler to said extended position when one of said heat sensors generates said actuation signal.

7. The system of claim 1, further comprising said nozzle of each said sprinkler being a plurality of nozzles, said line of each said sprinkler being fluidically coupled to each said nozzle of said plurality of nozzles.

8. The system of claim 1, further comprising said line of each said sprinkler being elongated between said base and said distal end, said nozzle facing away from a central longitudinal axis of said line.

9. The system of claim 7, further comprising said line of each said sprinkler being elongated between said base and said distal end, each said nozzle facing away from a central longitudinal axis of said line.

10. The system of claim 1, further comprising:
said fire retardant fluid being a primary fire retardant fluid;
said tank being a primary tank containing said first fire retardant fluid;
a second fire retardant fluid;
a secondary tank containing said second fire retardant fluid;
said plurality of sprinklers comprising a plurality of primary sprinklers and a plurality of secondary sprinklers, said primary sprinklers being positioned farther from said structure than said secondary sprinklers;
said pump being a primary pump, said primary pump being fluidically coupled to said primary tank and said plurality of primary sprinklers, said primary pump selectively pumping said first fire retardant fluid to said base of each said primary sprinkler and through each said primary sprinkler such that said first fire retardant fluid is dispensed onto an outer portion of said ground surface surrounding said structure;
a secondary pump being fluidically coupled to said secondary tank and said plurality of secondary sprinklers, said secondary pump selectively pumping said second fire retardant fluid to said base of each said secondary sprinkler and through each said secondary sprinkler such that said second fire retardant fluid is dispensed onto one of an inner portion of said ground surface surrounding said structure and a top side of said structure; and
said CPU being operable to actuate one of said primary pump and said secondary pump when one of said heat sensors generates said actuation signal.

11. The system of claim 10, further comprising said plurality of said secondary sprinklers being positioned along a secondary boundary surrounding said structure, said plurality of said primary sprinklers being positioned along a primary boundary surrounding said structure and said secondary boundary.

12. The system of claim 10, further comprising:
said plurality of heat sensors being a plurality of primary heat sensors, each said primary heat sensor being positioned proximate a respective primary sprinkler of said plurality of primary sprinklers, each said primary heat sensor being operationally and signally coupled to said CPU, each said primary heat sensor being configured for generating a primary actuation signal if detecting a first predetermined rate of heat, said CPU being operable to actuate said primary pump when one of said primary heat sensors generates said primary actuation signal; and
a plurality of secondary heat sensors, each said secondary heat sensor being positioned proximate a respective secondary sprinkler of said plurality of secondary sprinklers, each said secondary heat sensor being operationally and signally coupled to said CPU, each said secondary heat sensor being configured for generating a secondary actuation signal if detecting a second predetermined rate of heat, said CPU being operable to actuate said secondary pump when one of said secondary heat sensors generates said secondary actuation signal.

13. The device of claim 12, further comprising said line of each said sprinkler being movable between a retracted position and an extended position, said CPU being operable to move said line of each said primary sprinkler to said extended position when one of said primary heat sensors generates said actuation signal, said CPU being operable to move said line of each said secondary sprinkler to said extended position when one of said secondary heat sensors generates said actuation signal.

14. The device of claim 10, further comprising said secondary pump selectively pumping said second fire retardant fluid to said base of each said secondary sprinkler and through each said secondary sprinkler such that said second fire retardant fluid is dispensed onto an inner portion of said ground surface surrounding said structure and onto a top side of said structure.

15. The system of claim 10, further comprising said first fire retardant fluid having an equivalent composition as said second fire retardant fluid.

16. A fire protection system comprising:
a ground surface;
a structure positioned on said ground surface;
a first fire retardant fluid;
a second fire retardant fluid;
a primary tank containing said first fire retardant fluid;
a secondary tank containing said second fire retardant fluid;
a plurality of sprinklers, each said sprinkler having a base being embedded below said ground surface, each said sprinkler having a line telescopically coupled to said base and extending outwardly away from said ground surface, said line being movable between a retracted position and an extended position, said line being positioned entirely under said ground surface in said retracted position, said line being positioned entirely above said ground surface in said extended position, each said sprinkler having a plurality of nozzles at a distal end of said line relative to said ground surface, said line being fluidically coupled to each said nozzle of said plurality of nozzles and said base, said line being elongated between said base and said distal end, each said nozzle facing away from a central longitudinal axis of said line, said plurality of sprinklers comprising a plurality of primary sprinklers and a plurality of secondary sprinklers, said plurality of said secondary sprinklers being positioned along a secondary boundary surrounding said structure, said plurality of said primary sprinklers being positioned along a primary boundary surrounding said structure and said secondary boundary;
a primary pump being fluidically coupled to said primary tank and said plurality of primary sprinklers, said primary pump selectively pumping said first fire retardant fluid to said base of each said primary sprinkler and through each said primary sprinkler such that said first fire retardant fluid is dispensed onto an outer portion of said ground surface surrounding said structure;
a secondary pump being fluidically coupled to said secondary tank and said plurality of secondary sprinklers, said secondary pump selectively pumping said second fire retardant fluid to said base of each said secondary sprinkler and through each said secondary sprinkler such that said second fire retardant fluid is dispensed onto an inner portion of said ground surface surrounding said structure and onto a top side of said structure;
a central processing unit (CPU) being operationally coupled to said primary pump and said secondary pump, said CPU being operationally coupled to said plurality of sprinklers, said CPU selectively moving said line of each said sprinkler between said retracted position and said extended position;
a plurality of primary heat sensors, each said primary heat sensor being positioned proximate a respective primary sprinkler of said plurality of primary sprinklers, each said primary heat sensor being operationally and signally coupled to said CPU, each said primary heat sensor being configured for generating a primary actuation signal if detecting a first predetermined rate of heat, said CPU being operable to move said line of each said primary sprinkler to said extended position and actuate said primary pump when one of said primary heat sensors generates said primary actuation signal; and
a plurality of secondary heat sensors, each said secondary heat sensor being positioned proximate a respective secondary sprinkler of said plurality of secondary sprinklers, each said secondary heat sensor being operationally and signally coupled to said CPU, each said secondary heat sensor being configured for generating a secondary actuation signal if detecting a second predetermined rate of heat, said CPU being operable to move said line of each said secondary sprinkler to said extended position and actuate said secondary pump when one of said secondary heat sensors generates said secondary actuation signal.
